(19) United States
(12) Patent Application Publication
(10) Pub. No.: US 2021/0237527 A1
(43) Pub. Date: Aug. 5, 2021

(54) WHEEL SUSPENSION SYSTEM

(71) Applicant: Svela TrailerTech AS, Fredrikstad (NO)

(72) Inventor: Sverre Egil LARSEN, Fredrikstad (NO)

(73) Assignee: Svela TrailerTech AS, Fredrikstad (NO)

(21) Appl. No.: 17/049,108

(22) PCT Filed: Apr. 23, 2019
(86) PCT No.: PCT/NO2019/050088

§ 371 Date: Oct. 20, 2020

(30) Foreign Application Priority Data
Apr. 21, 2018 (NO) 20180557

(51) Int. Cl. B60G 7/02; B60G 5/06; B60G 11/18

(52) U.S. Cl. CPC B60G 7/02; B60G 5/065; B60G 11/185; B60G 2206/73; B60G 2300/04; B60G 2202/134; B60G 2206/724; B60G 2204/1434

(57) ABSTRACT

It is disclosed a system for leveling of load between front and rear wheels on a trailer, consisting of a rubber-torsion axle FIG. D with longitudinal members 4 which center is pivotally mounted to the torsion axles pivot arms 7. With a wheel in each end of the longitudinal members, the system is working as a complete bogie unit which has vertical spring motion effect, as shown in FIG. B. For trailers with no need of such spring motion effect, the longitudinal members can be mounted direct to the inner tube 9 in the rubber-torsion element.

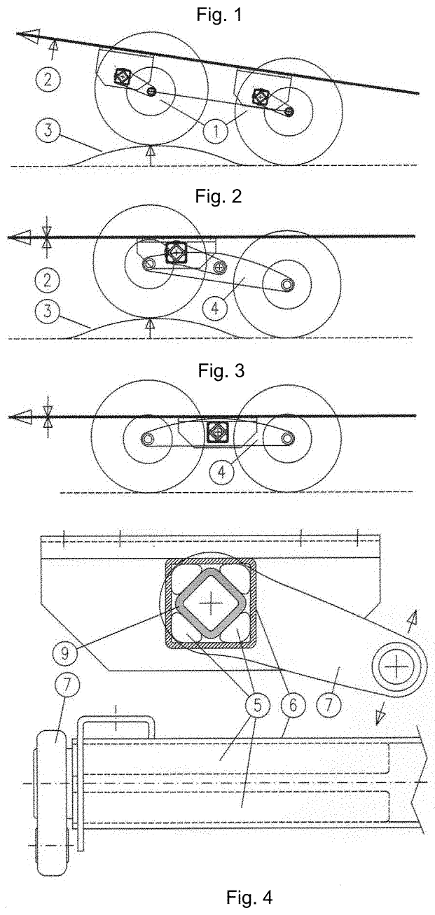

### FIELD OF THE INVENTION

The present invention relates to building trailers with torsion suspension axles combined with wheels mounted on weight equalizing bogie members.

### BACKGROUND

Currently there exist several different types of wheel suspensions for car trailers, but for trailers with a total weight up to 3500 kg, leaf springs, coil springs or rubber-torsion axles are the most common. In USA leaf springs are mostly preferred and in Europe rubber torsion axles are predominant.

When building trailers for maximum 3500 kg gross weight with four wheels, it is most commonly used two single axles with individual suspension after each other on the same framework, without any mutual mechanical link. Even though this construction is most used, it has some serious drawbacks, which will be solved by the present invention.

One drawback is that wheels on front and rear axles almost never are evenly loaded, which may cause poor driving characteristics and even dangerous situations. The reasons for this are that even if the trailer has equal weight on all four wheels before connected to the tow bar, this may change dramatically when the ball joint is attached. This because if the pulling vehicle's tow bar ball is lower than the trailers ball joint, the front axle of trailer will carry more load than the rear axle, and vice versa.

Even if trailer is horizontally leveled and all wheels are carrying evenly static load after the ball joint is connected to the pulling vehicle's tow bar, this will change as soon as driving starts. When moving, loading rates on axles and tow bar will change continuously, caused by uneven road conditions and brake/acceleration forces. This creates series of up and down movements of car and trailer, which the driver sometimes may feel as a bit unpleasant, but driving straight ahead will normally not cause any great problems. When driving in turns, on the other hand, these vertical movements may change the driving characteristics dramatically.

The frictional resistance between wheels and road is preventing the trailer from slipping sideways in turns by centrifugal force. Since the center of this frictional resistance is varying between the two axles when driving on an uneven road, the distance between this friction center and the trailer's ball joint is also variable.

These variations of friction/load center combined with variations in vertical load and height of the pulling vehicle's tow bar, will in turns create sideways forces that may start dangerous commuting of trailer. Such commuting tend to be self-enforcing and have caused many serious accidents over the years.

Trailers with one axle do obviously not have such problems, because the distance from ball joint to wheel center is constant, but driving with negative load on ball joint/tow bar can start dangerous self-reinforcing commuting on any trailer, regardless of number of axles.

Two wheels mounted in a bogie suspension, where both wheels have the same distance to bogie center, gives the same advantages as a single axle, because the distance from ball joint to bogie center is always constant and so is the center of frictional resistance between wheels and road, because the wheels have equal loads. The small variation in distance occurring when the wheel- or bogiecenter moves vertically along a curve determined by the pivot arm's length, is here ignored.

Bogie mounting of wheels are commonly used on trains, trucks and heavy trailers, but is rarely used on trailers and caravans up to 3500 kg total weight, presumably because the usual bogie suspension systems are relatively complicated, heavy and have high manufacturing costs.

Bogie is an expression originating from train terminology meaning an arrangement for supporting the end of a long railroad car, the arrangement including two sets of wheels in tandem allowed to swivel around a vertical axis. In popular terminology it means a system for supporting a trailer including two sets of wheels in tandem.

U.S. Pat. No. 4,460,196 describes a system for connecting two axles on a truck. The system comprises a pair of rigid arms each pivotable mounted at one end on a central pivot projecting from the truck frame and at the other end to one of the axles. Each of the rigid arms has an upwardly projecting bracket portion for mounting therebetween resilient means adapted to be deformed by the oscillations of the rigid arms about the central pivot to receive the load on the truck and compensate for differences in height between the pair of axles.

A somewhat similar suspension system for truck with two rear axles is also described in WO 2006/130077.

### SUMMARY OF THE INVENTION

The object of this invention is to provide a bogie suspension system for trailers, which have four wheels mounted on one single torsion axle and gives a 100% equalizing of load between front and rear wheels on each side. This design gives better and safer driving characteristics than two separate axles, mainly because the distance between bogie center and ball joint is kept constant, regardless of external influences.

This object is obtained by the invention as defined in the appended patent claims.

This invention is a simplified version of a bogie suspension, consisting of an ordinary rubber-torsion axle, which have a longitudinal member mounted to each of the pivot-arms. The torsion element in each end of the axles main body may even be a rod made of spring steel or other material, but the rubber torsion suspension is most likely to be used because of its self-damping effect, low manufacturing cost and durability.

The longitudinal members can also be mounted direct to the inner tube of the rubber-torsion axle, instead of to the pivot arms. Then the rubber bars will function as a vibration-damping bearing point and give some resistance against the up and down movements of the wheels on an uneven road path, but they will have no vertical spring motion effect.

### DESCRIPTION OF THE DRAWINGS

The attached drawing is meant to schematically show the principal function of the basic and well-known rubber-torsion axle and how driving characteristics for both car and trailer are improved by implementing the invention's bogie suspension system.

FIG. A shows a schematic drawing of how a conventional trailer with two separate rubber torsion axles reacts when a front wheel hits a bump in the road. The trailer's drawbar 2 and ball joint goes up and gives the rear end of the pulling vehicle a lift:

The trailer includes two separate rubber-torsion axles 1, and a draw bar 2 with ball joint. When passing a road bump 3, the front end of the draw bar 2 will go up. However, the car will partly prevent this, and instead the trailer's rear wheels will be lifted with the result that both the car's and the trailer's rear wheels will have less ground pressure.

FIG. B shows how a trailer with one rubber torsion axle and the invention's bogie-member system acts in the same situation. The system includes a rubber torsion axle with a pivot arm at each end thereof, each pivot arm having a first end connected to the axle and a second end projecting therefrom. On each side of the trailer there is a longitudinal bogie member 4 connecting the front and rear wheels 1. The second end of each pivot arm is hinged to the middle of the corresponding bogie member 4. When passing the road bump 3 the drawbar 2 with ball joint are kept in an almost level position. The rubber torsion axle may be replaced with a steel-rod torsion axle.

FIG. C shows how a longitudinal bogie-member 4 can be mounted directly to the inner tube of a rubber-torsion axle without pivot arms. Mounted this way, the rubber bars in the rubber-torsion axle keeps the inner tube and longitudinal members in a firm but elastic and vibration damping grip, but it gives no vertical spring motion effect. Also here the rubber torsion axle may be replaced with a steel torsion axle.

FIG. D shows the well-known principle of a basic rubber-torsion axle, where the upper part shows the axle in cross section and the lower part is a view along the axle.

Solid rubber bars 5 are squeezed between inner 9 and outer 6 square tubes when the pivot arm 7 is moved. The square tube 6 forms the torsion axle's main body. The longitudinal member is pivotally mounted on the pivot arm 7. The torsion axle may be a continuous unit spanning the width of the trailer chassis, or it may consist of two parts, i.e. two separate torsion elements mounted one on each side of the chassis.

1. A wheel suspension system for a trailer with four wheels, wherein the system is adapted to equalize the trailer's weight between front and rear wheels, comprising:
a transverse torsion axle including a pivot arm at each end,
each pivot arm having a first end rigidly fastened to the torsion axle's rotatable inner member, and
wherein the other end of the pivot arm is pivotably connected to a central point of a longitudinal member, each longitudinal member having a wheel mounted on each of its ends.

2. A wheel suspension system according to claim 1, wherein the torsion axle either includes torsion elements mounted in one transverse axle body of full width or as two separate torsion elements mounted one on each side of the trailer.

3. A wheel suspension system according to claim 1, wherein the torsion axle includes rubber torsion elements with three or more solid rubber bar.

4. A wheel suspension system according to claim 1, wherein the torsion elements include a bar of spring steel.

5. A wheel suspension system according to claim 1, wherein the longitudinal members are connected directly to the torsion axle's rotatable inner members, without pivot arms.
